(19) United States
(12) Patent Application Publication
(10) Pub. No.: US 2001/0023263 A1
(43) Pub. Date: Sep. 20, 2001

(54) Production of polyurethane foams

(76) Inventors: Bernd Bruchmann, Freinsheim (DE); Armin Becker, GroBnidesheim (DE); Heniz-Dieter Lutter, Diepholz (DE); Dietrich Scherzer, Neustadt (DE); Harald Schafer, Mannheim (DE)

Correspondence Address: BASF Corporation, Patent Department, 1419 Biddle Avenue, Wyandotte, MI, 48192-3736, US

(21) Appl. No.: 09/781,725

(22) Filed: Feb. 12, 2001

(30) Foreign Application Priority Data
Feb. 12, 2000 (DE) 10006340.3

(51) Int. Cl. C08J 9/04; C08L 75/04; C08L 69/00; C08L 77/00; C08L 71/00

(52) U.S. Cl. 521/137; 252/182.24; 521/155; 521/170

(57) ABSTRACT

In a process for producing polyurethane foams by reacting isocyanates with compounds having at least two hydrogen atoms which are reactive toward isocyanate groups, the isocyanates used are (cyclo)aliphatic isocyanates and the reaction is carried out in the presence of substances which effect framework formation in the polyurethane foam.

The present invention relates to a process for producing polyurethane foams by reacting aliphatic isocyanates with compounds having at least two hydrogen atoms which are reactive toward isocyanate groups.

Polyurethane foams have been known for a long time and are widely described in the literature. They are usually produced by reacting isocyanates with compounds having at least two hydrogen atoms which are reactive toward isocyanate groups. Isocyanates used are mostly aromatic diisocyanates and polyisocyanates, with isomers of tolylene diisocyanate (TDI), isomers of diphenylmethane diisocyanate (MDI) and also mixtures of diphenylmethane diisocyanate and polymethylenepolyphenylene polyisocyanates (crude MDI) having the greatest industrial importance.

However, such polyurethane foams based on aromatic isocyanates tend to suffer from yellowing under the action of light. This yellowing tendency is undesirable for many application areas. It is known that polyurethanes which have been produced using aliphatic isocyanates are stable to light and display virtually no yellowing. However, the use of aliphatic isocyanates for producing polyurethane foams has the disdvantage that the foams produced in this way are mostly significantly inferior to those based on aromatic isocyanates in many respects, in particular in terms of their mechanical properties. In particular, the unsatisfactory formation of hard and soft phase segments in the fully polymerized foam results in inferior values for important material properties such as elongation, tensile strength and flexibility.

Thus, WO 98/52987 describes the production of lightfast polyurethane foams using aliphatic isocyanates and hydrogenated polydiene diols as compounds having at least two hydrogen atoms which are reactive toward isocyanate groups. However, such diols are more expensive than the alcohols customarily used. In addition, these foams display a deterioration in their mechanical properties under the action of light and become sticky.

EP-A-911 354 describes lightfast polyurethane foams which are produced using aliphatic isocyanates. The polyol components used in the foams described in EP-A-911 354 are also polyols which are prepared by in-situ polymerization of olefinically unsaturated monomers in polyether alcohols. Moreover, styrene is used as one of the olefinically unsaturated monomers for producing these polyols, and this likewise leads to yellowing of the foams due to its aromatic ring.

DE 198 20 917 describes polyurethane foams to which polyethylene waxes are added to reduce dust formation during working, in particular cutting, of the foams and to obtain good surfaces after cutting. This document also mentions the production of aliphatic foams. A disadvantage of this process is that the waxes described can over time migrate from the foam.

It is an object of the present invention to provide light-stable polyurethane foams which have good mechanical properties and can be produced using starting materials customary in polyurethane chemistry.

We have found that this object is achieved by carrying out the reaction for producing polyurethane foams based on aliphatic isocyanates in the presence of polymeric substances which effect framework formation in the polyurethane foam.

The present invention accordingly provides a process for producing polyurethane foams by reacting isocyanates with compounds having at least two hydrogen atoms which are reactive toward isocyanate groups, wherein the isocyanates used are (cyclo)aliphatic isocyanates and the reaction is carried out in the presence of lightfast substances which effect framework formation in the polyurethane foam.

The invention further provides polyurethane foams which can be produced by the process of the present invention. The invention can be employed for producing all types of polyurethane foams, either flexible foams, rigid foams or integral foams.

For the purposes of the present invention, “lightfast” refers to substances which display no color change, also referred to as yellowing, even after prolonged exposure to light.

As lightfast substances which effect framework formation in the polyurethane foam, use is made, in particular, of organic polymers. Preference is given to using those organic polymers which are soluble or dispersible in at least one of the starting components for producing the polyurethane foams. The substances which effect framework formation in the polyurethane foam are preferably added only to the component which comprises the compounds having at least two hydrogen atoms which are reactive toward isocyanate groups, namely the polyol component.

The polyol components obtained in this way surprisingly have satisfactory storage stability, i.e. no demixing of the polyol component takes place over a production-relevant period of 24 hours.

In principle, all addition polymers, polyaddition products or polycondensation products are suitable as substances which effect framework formation in the polyurethane foam. Exceptions are polymers which can lead to yellowing of the polyurethane foams. These are, in particular, polymers which contain aromatic structures. As substances which effect framework formation in the polyurethane foam, it is possible to use both ones containing groups which are reactive toward the functional groups of the starting materials for the polyurethane synthesis and also ones which contain no groups of this type.

As lightfast substances which effect framework formation in the polyurethane foam, it is possible to use ones which are incorporated into the polyurethane matrix via functional groups. These functional groups can react with the functional groups of at least one of the starting components for the polyurethane foam.

As lightfast substances which can be incorporated into the polyurethane matrix via functional groups, preference is given to using ones selected from the group consisting of polymers of (meth)acrylic acid, esterified polyacrylic acids, polymethyl methacrylates, polyhydroxyacrylates, polyvinylamines, polyvinyl alcohols, polyethyleneimines and copolymers of these compounds with other olefinically unsaturated monomers, preferably aliphatic comonomers because of the yellowing tendency of aromatic radicals.

The substances which are incorporated into the polyurethane matrix via functional groups preferably have a molecular weight M_{w} in the range from 500 to 50,000 Da.

It is advantageous here for the functional groups of the substances which effect framework formation in the polyurethane foam not to be able to react with the functional groups of the starting component in which they are dissolved or dispersed, since otherwise crosslinking of the starting component can occur, leading to a great increase in the viscosity and problems in processing.

The lightfast framework-forming substances used according to the present invention can also be polymers which are not incorporated into the polyurethane matrix via functional groups.

The substances which are not incorporated into the polyurethane matrix are preferably selected from the group consisting of polyethylene, polypropylene, polyoxymethylene, polyamide, polycarbonate, polyvinyl chloride, polyvinylpyrrolidone, polytetrafluoroethylene, polybutadiene, polyisoprene and polyacrylonitrile. The substances which are not incorporated into the polyurethane matrix have, in particular, a molecular weight M_{w} in the range from 10,000 to 500,000 Da, so as to prevent migration of these substances from the polymer framework.

The amount of the substances which effect framework formation in the polyurethane foam should be such that a noticeable buildup of the foam framework takes place but the known good product properties of the polyurethanes are not adversely affected and the viscosity of the polyurethane-formative components into which these substances are introduced does not increase so much that processing of these substances is made difficult or even impossible. The lower limit for the amount of substances which ensure the stability of the polyurethane foam is preferably 0.1% by weight, particularly preferably 0.5% by weight, in each case based on the weight of the polyurethane foam. The upper limit for the amount of substances which ensure the stability of the polyurethane foam is preferably 50% by weight, particularly preferably 30% by weight, in each case based on the weight of the polyurethane foam.

As regards the starting materials necessary for carrying out the process of the present invention and also the auxiliaries and additives, the following details may be provided.

As polyisocyanates, it is possible to use the customary and known (cyclo)aliphatic diisocyanates, triisocyanates and polyisocyanates. Examples of (cyclo)aliphatic diisocyanates and triisocyanates are tetramethylene 1,4-diisocyanate, hexamethylene 1,6-diisocyanate, isophorone diisocyanate, 2-methylpentamethylene diisocyanate, 2,2,4- or 2,4,4-trimethylhexamethylene 1,6-diisocyanate, 2-butyl-2-ethylpentamethylene diisocyanate, 1,4-diisocyanatocyclohexane, 3-isocyanatomethyl-1-methyl-1-isocyanatocyclohexane, isocyanatopropylcyclohexyl isocyanate, xylylene diisocyanate, tetramethylxylylene diisocyanate, bis(4-isocyanatocyclohexyl)methane, lysine ester isocyanates, 1,3- or 1,4-bis(isocyanatomethyl)cyclohexane, 4-isocyanatomethyloctamethylene 1,8-diisocyanate and their mixtures as well as the oligoisocyanates or polyisocyanates prepared therefrom. The oligoisocyanates or polyisocyanates can be prepared from the abovementioned diisocyanates or triisocyanates or their mixtures by coupling via urethane, allophanate, urea, biuret, uretdione, amide, isocyanurate, carbodiimide, uretonimine, oxadiazinetrione or iminooxadiazinedione structures.

As compounds having at least two active hydrogen atoms, use is made, in particular, of polyester alcohols and preferably polyetherols having a functionality of from 2 to 8, in particular from 2 to 4, preferably from 2 to 3, and a mean molecular weight in the range from 400 to 10,000 Da, preferably from 1000 to 8000 Da. The polyether alcohols can be prepared by known methods, usually by catalytic addition of alkylene oxides, in particular ethylene oxide and/or propylene oxide, onto H-functional starter substances, or by condensation of tetrahydrofuran. H-functional starter substances used are, in particular, polyfunctional alcohols and/or amines. Preference is given to using water, dihydric alcohols, for example ethylene glycol, propylene glycol or butanediols, trihydric alcohols, for example glycerol or trimethylolpropane, and also higher-functionality alcohols such as pentaerythritol, sugar alcohols, for example, sucrose, glucose or sorbitols. Preferred amines are aliphatic amines having up to 10 carbon atoms, for example ethylenediamine, diethylenetriamine, propylenediamine, and also amino alcohols such as ethanolamine or diethanolamine. The polymer-modified polyether alcohols also include polyether alcohols containing polyurea dispersions.

In the process of the present invention, preference is given to using polyether alcohols which have primary hydroxyl groups, in particular those having an ethylene oxide block at the end of the chain or those based on only ethylene oxide.

The compounds having at least two active hydrogen atoms also include chain extenders and crosslinkers, which can be additionally used if desired. As chain extenders and crosslinkers, preference is given to using 2- and 3-functional alcohols having molecular weights below 400 Da, in particular in the range from 60 to 150 Da. Examples are ethylene glycol, propylene glycol, diethylene glycol and 1,4-butanediol. As crosslinkers, it is also possible to use diamines. If chain extenders and crosslinkers are used, they are preferably used in an amount up to 5% by weight, based on the weight of the compounds having at least two active hydrogen atoms.

In carrying out the process of the present invention, it is possible to use further starting materials, in particular catalysts, blowing agents and also auxiliaries and/or additives, about which the following details may be provided:

Catalysts used for producing the polyurethane foams of the present invention are the customary and known polyurethane formation catalysts, for example organic tin compounds such as tin diacetate, tin dioctoate, dialkyltin dilaurate, and/or strongly basic amines such as triethylamine, pentamethyldiethylenetriamine, bis(dimethylaminoethyl) ether, imidazoles or preferably triethylenediamine. The catalysts are preferably used in an amount of from 0.01 to 5% by weight, preferably from 0.05 to 2% by weight.

As blowing agent for producing the polyurethane foams, preference is given to using water which reacts with the isocyanate groups to liberate carbon dioxide. Together with or in place of water, it is also possible to use physically acting blowing agents, for example carbon dioxide, hydrocarbons such as n-pentane, isopentane or cyclopentane, cyclohexane or halogenated hydrocarbons such as tetrafluoroethane, pentafluoropropane, heptafluoropropane, pentafluorobutane, hexafluorobutane or dichloromonofluoroethane. The amount of physically acting blowing agent is preferably in the range from 1 to 15% by weight, in particular from 1 to 10% by weight, and the amount of water is preferably in the range from 0.5 to 10% by weight, in particular from 1 to 5% by weight.

Examples of auxiliaries and/or additives which may be used are surface-active substances, foam stabilizers, cell regulators, external and internal mold release agents, fillers, pigments, hydrolysis inhibitors and also fungistatic and bacteriostatic substances.

In the industrial production of polyurethane foams, it is customary to combine the compounds having at least two active hydrogen atoms and the further starting materials, as well as auxiliaries and/or additives, to give a polyol component prior to the reaction.

Further information regarding the starting materials used may be found, for example, in Kunststoffhandbuch, Volume 7, Polyurethane, edited by Günter Oertel, Carl-Hanser-Verlag, Munich, 3^{rd} edition 1993.

To produce the polyurethanes of the present invention, the organic polyisocyanates are reacted with the compounds having at least two active hydrogen atoms in the presence of the framework-forming substances used according to the present invention and also the abovementioned blowing agents, catalysts and auxilaries and/or additives (polyol component), with the polymers of the present invention which effect framework formation in the foam preferably being added to the polyol component.

In the production of the polyurethanes of the present invention, the isocyanate and polyol components are reacted in such amounts that the equivalence ratio of isocyanate groups to the sum of active hydrogen atoms is from 0.7:1 to 1:1.25, preferably from 0.8:1 to 1:1.20.

The polyurethane foams are preferably produced by the one-shot method, for example with the aid of the high-pressure or low-pressure technique. The foams can be produced in open or closed metallic molds or by continuous application of the reaction mixture to conveyor belts to produce foam blocks.

It is particularly advantageous to employ the two-component process in which, as mentioned above, a polyol component and an isocyanate component are prepared and foamed. The components are preferably mixed at from 15 to 120° C., preferably from 20 to 80° C., and introduced into the mold or applied to the conveyor belt. The temperature in the mold is usually in the range from 15 to 120° C., preferably from 30 to 80° C.

The polyurethane foams produced by the process of the present invention have very good mechanical properties which correspond to those of foams based on aromatic isocyanates. Furthermore, they have a white color and excellent light stability.

The invention is illustrated by the following examples.

### EXAMPLES 1 TO 6

Firstly, a polyol component is prepared from the compounds indicated in Table 1. This polyols component and the isocyanate component likewise indicated in Table 1 are separately heated to 60° C., combined at this temperature, homogenized by means of a stirrer and poured into a 40×40×10 cm closed mold which has been heated to 60° C. The resulting foam is cured at 60° C.

The properties of the foams produced according to the present invention are recorded in Tables 2 and 3.

TABLE 1
Components for producing the foams according to the
present invention, in % by weight.

| Example | 1 | 2 | 3 | 4 | 5 | 6 |
|---|---|---|---|---|---|---|
| Basonat HI 100 | 37.0 | | | 37.8 | | |
| Basonat P LR 8926 | | 39.2 | 39.9 | | 31.7 | 41.9 |
| Lupranol 1200 | 18.5 | 17.8 | 18.2 | 18.9 | | 19.5 |
| Lupranol 2045 | 30.8 | 29.7 | 30.2 | 31.4 | | 31.9 |
| Lupranol 2043 | | | | | 56.0 | |
| Lupranol 3402 | | | | | 1.7 | |
| Pluriol E 400 | | | | | 1.7 | |
| Sokalan PA 40 | 6.2 | 5.9 | 6.1 | 6.3 | | 6.3 |
| Sokalan HP 50 | 5.5 | 5.3 | | 5.7 | | |
| Superabsorbent | | | 5.4 | | | |
| Lumitol H 136¹⁾ | | | | | 6.8 | |
| DBTL | 0.2 | 0.2 | 0.2 | 0.2 | 0.4 | 0.4 |
| Lupragen N 206 | | | | | 0.7 | |
| DC 193 | | | | | 0.35 | |
| Cyclohexane | 1.9 | 1.8 | | | | |
| Water | | | | | 0.70 | |

¹⁾The Lumitol was freed of solvent before use

Starting materials:

| Basonat ® HI 100: | polyisocyanate derived from hexamethylene |
|---|---|
| | diisocyanate (HDI), NCO content: 22.0% by |
| | weight |
| Basonat ® P LR 8926: | polyisocyanate derived from HDI, NCO content: |
| | 19.0% by weight |
| Lupranol ® 1200: | polyoxypropylenediol, hydroxyl number: |
| | 250 mg KOH/g |
| Lupranol ® 2045: | polyoxypropylene-polyoxyethylenetriol, |
| | hydroxyl number: 35 mg KOH/g |
| Lupranol ® 2043: | polyoxypropylene-polyoxyethylenetriol, |
| | hydroxyl number: 29 mg KOH/g |
| Lupranol ® 3402: | tetrol, hydroxyl number: 470 mg KOH/g |
| Pluriol ® E 400: | polyoxyethylenediol, hydroxyl number: 280 mg |
| | KOH/g |
| Sokalan ® PA 40: | solid polyacrylic acid, M_{w} 15,000 g/mol |
| Sokalan ® HP 50: | solid polyvinylpyrrolidone, M_{w} 40,000 g/mol |
| Superabsorbent: | polyacrylic acid sodium salt, M_{w} 20,000 g/mol |
| Lumitol ® H 136: | OH acrylate resin, solids content: 70%, |
| | hydroxyl number: 135 mg KOH/g |
| DBTL: | dibutyltin dilaurate |
| Lupragen ® N 206: | bis(N,N-dimethylaminoethyl) ether, 70% |
| | strength in dipropylene glycol |
| DC 193: | DABCO ® DC 193, silicone stabilizer, |
| | from Air Products |
| The products denoted by ® are, with the exception of DABCO ® DC 193, products of | |
| # BASF Aktiengesellschaft | |

TABLE 2
Properties of the foams produced according to the
present invention

| Example | 1 | 2 | 3 | 4 | 5 | 6 |
|---|---|---|---|---|---|---|
| Density (g/l) in | 180.00 | 151.00 | 246.00 | 230.00 | 186.00 | 202.00 |
| accordance | | | | | | |
| with DIN | | | | | | |
| EN ISO 845 | | | | | | |
| Compressive | 0.22 | 0.44 | 0.66 | 1.27 | 0.47 | 0.13 |
| set, 23° C., | | | | | | |
| 50% defor- | | | | | | |
| mation, 72 h | | | | | | |
| loading (%) (in | | | | | | |
| accordance | | | | | | |
| with DIN | | | | | | |
| 53572) | | | | | | |
| Compressive | 2.75 | 2.45 | 5.41 | 3.00 | 0.56 | 3.76 |
| set, 70° C., | | | | | | |
| 50% defor- | | | | | | |
| mation, 22 h | | | | | | |
| loading (%) (in | | | | | | |
| accordance | | | | | | |
| with DIN | | | | | | |
| 53572) | | | | | | |
| Tensile | 52.30 | 21.30 | 63.10 | 70.60 | 45.90 | 57.20 |
| strength (kPa) | | | | | | |
| (in accordance | | | | | | |
| with DIN | | | | | | |
| 53571) | | | | | | |
| Compressive | 22.50 | 7.40 | 32.70 | 49.70 | 17.80 | 17.60 |
| strength (kPa) | | | | | | |
| at 40% (in | | | | | | |
| accordance | | | | | | |
| with DIN | | | | | | |
| 53577) | | | | | | |
| Tear prop- | 225.00 | 104.00 | 254.00 | 327.00 | 181.00 | 201.00 |
| agation test | | | | | | |
| using the | | | | | | |
| Graves method | | | | | | |
| (kpa) (in | | | | | | |
| accordance | | | | | | |
| with DIN | | | | | | |
| 53515) | | | | | | |
| Rebound | 27.80 | 36.50 | 41.60 | 23.70 | 36.10 | 38.20 |
| resilience | | | | | | |
| (%) in | | | | | | |
| accordance | | | | | | |
| with DIN | | | | | | |
| 53573 | | | | | | |

Irradiation test in accordance with ISO 4892-2: the foam No. 5 produced according to the present invention was tested in comparison with a commercial flexible polyurethane foam based on tolylene diisocyanate in the irradiation apparatus ×450 from Heraeus. Here, samples of the two foams having dimensions of 60×50×10 mm were subjected to a 5-day test and the discoloration was subsequently determined by means of the Yellowness Index. The foam based on the aromatic isocyanate was brown after the test, while the foam produced according to the present invention displayed no visible discoloration.

TABLE 3
Yellowness Indices of the irradiated specimens

| | Foam No. 5 | |
|---|---|---|
| Yellowness Index in | (according to the | |
| accordance with ASTM D | present | TDI foam |
| 1925-70 (1988) | invention) | (comparison) |
| 0 d | 4.9 | 5.6 |
| 5 d | 8.3 | 79.9 |

We claim:

1. A process for producing polyurethane foams by reacting isocyanates with compounds having at least two hydrogen atoms which are reactive toward isocyanate groups, wherein the isocyanates used are (cyclo)aliphatic isocyanates and the reaction is carried out in the presence of lightfast substances which effect framework formation in the polyurethane foam.

2. A process as claimed in claim 1, wherein the substances which effect framework formation in the polyurethane foam are organic polymers.

3. A process as claimed in claim 1, wherein the substances which effect framework formation in the polyurethane foam are organic polymers which are soluble or dispersible in at least one of the starting components for producing the polyurethane foams.

4. A process as claimed in claim 1, wherein the substances which effect framework formation in the polyurethane foam are addition polymers, polyaddition products or polycondensation products.

5. A process as claimed in claim 1, wherein the substances which effect framework formation in the polyurethane foam are incorporated into the polyurethane matrix via functional groups.

6. A process as claimed in claim 5, wherein the substances which are incorporated into the polyurethane matrix via functional groups are selected from the group consisting of polymers of (meth)acrylic acid, esterified polyacrylic acids, polymethyl (meth)acrylates, polyhydroxy(meth)acrylates, polyvinylamines, polyethylenimines, polyvinyl alcohols and copolymers of these compounds with other olefinically unsaturated monomers.

7. A process as claimed in claim 5, wherein the substances which are incorporated into the polyurethane matrix via functional groups have a molecular weight Mw in the range from 500 to 50,000 Da.

8. A process as claimed in claim 1, wherein the substances which effect framework formation in the polyurethane foam are not incorporated into the polyurethane matrix.

9. A process as claimed in claim 8, wherein the substances which are not incorporated into the polyurethane matrix are selected from the group consisting of polyethylene, polypropylene, polyoxymethylene, polyamide, polycarbonate, polyvinyl acetate, polyvinyl chloride, polyvinylpyrrolidone, polytetrafluoroethylene, polybutadiene, polyisoprene and polyacrylonitrile.

10. A process as claimed in claim 8, wherein the substances which are not incorporated into the polyurethane matrix have a molecular weight Mw in the range from 10,000 to 500,000 Da.

11. A process as claimed in claim 1, wherein the substances which effect framework formation in the polyurethane foam are used in an amount of from 0.1% by weight to 50% by weight, based on the weight of the polyurethane foam.

12. A process as claimed in claim 1, wherein the substances which effect framework formation in the polyurethane foam are used in an amount of from 0.5% by weight to 30% by weight, based on the weight of the polyurethane foam.

13. A process as claimed in claim 1, wherein the substances which effect framework formation in the polyurethane foam are added to the compounds having at least two hydrogen atoms which are reactive toward isocyanate groups.

14. A storage-stable polyol component for producing polyurethane foams, comprising substances which effect framework formation in the polyurethane foam.

15. A polyurethane foam which can be produced as claimed in any of claims 1 to 14.
